(19) United States
(12) Patent Application Publication
(10) Pub. No.: US 2025/0238392 A1
(43) Pub. Date: Jul. 24, 2025

(54) METHOD FOR CONTROLLING A MOTOR CONTROLLER AND CONTROL SYSTEM

(71) Applicant: Richtek Technology Corporation, Zhubei City (TW)

(72) Inventors: I-Chi LIN, New Taipei City (TW); Bing-Siang HUANG, Puxin Township (TW); Chang-Yi LIN, Zhubei City (TW)

(21) Appl. No.: 18/748,466

(22) Filed: Jun. 20, 2024

(30) Foreign Application Priority Data
Jan. 24, 2024 (TW) 113102730

(51) Int. Cl. G06F 13/42; G06F 13/40

(52) U.S. Cl. CPC G06F 13/4291; G06F 13/4068; G06F 13/4295; G06F 2213/0016

(57) ABSTRACT

A method for controlling a motor controller is provided. The method includes, in a first mode: transmitting a control signal from a fan controller to a first motor controller through a first line. The method further includes, in the first mode, transmitting a control signal from a fan controller to a first motor controller through a first line. The method further includes, in the first mode, setting a voltage of the second line to a specific level of voltage to inform the first motor controller to enter a second mode using the fan controller. The method further includes, in the second mode, applying an Inter-Integrated Circuit (I²C) protocol to communicate between the fan controller and the first motor controller using the first line as a serial clock line (SCL) and using the second line as a serial data line (SDA).

### CROSS REFERENCE TO RELATED APPLICATIONS

This application claims priority of Taiwan Patent Application No. 113102730, filed on Jan. 24, 2024, the entirety of which is incorporated by reference herein.

### BACKGROUND OF THE INVENTION

### Field of the Invention

The present invention relates to fan controllers and motor controllers, and, in particular, to a control method with two modes.

### Description of the Related Art

When controlling multiple fans using a fan controller, the fans need to be connected to the fan controller. When there is a large number of fans to control, the fan controller need to have a very large number of pins. Also, hubs, splitters, and/or repeaters may be required to connect the fans to the fan controller. This has a higher hardware cost. Furthermore, current fan controllers can only obtain the rotation speed of the fans; they are not able to obtain other information about the fans' operation. Lack of access to information other than rotation speed is a disadvantage for the operator to understand the operation of the fan.

Thus, the fan controller and the method for controlling the fan still need to be improved to solve the aforementioned problems.

### BRIEF SUMMARY OF THE INVENTION

An embodiment of the present invention provides a method for controlling a motor controller. The method comprises, in a first mode: transmitting a control signal from a fan controller to a first motor controller through a first line. The method further comprises, in the first mode, transmitting a control signal from a fan controller to a first motor controller through a first line. The method further comprises, in the first mode, setting a voltage of the second line to a specific level of voltage (preset level of voltage) to inform the first motor controller to enter a second mode using the fan controller. The method further comprises, in the second mode, applying an Inter-Integrated Circuit (I²C) protocol to communicate between the fan controller and the first motor controller using the first line as a serial clock line (SCL) and using the second line as a serial data line (SDA).

An embodiment of the present invention provides a control system. The control system comprises a fan controller and a first motor controller, which is coupled to a first fan. The first motor controller is connected to the fan controller through a first line and a second line. In a first mode: the fan controller is configured to transmit a control signal to the first motor controller through the first line; the fan controller is configured to receive a first feedback signal from the first motor controller through the second line, wherein the control signal is configured to control a rotation speed of a first fan coupled to the first motor controller, and the first feedback signal corresponds to an actual rotation speed of the first fan; the fan controller is configured to set a voltage of the second line to a specific level of voltage to inform the first motor controller to enter a second mode. In the second mode: the fan controller and the first motor controller are configured to apply Inter-Integrated Circuit (I²C) protocol to communicate with each other using the first line as a serial clock line (SCL) and using the second line as a serial data line (SDA).

### BRIEF DESCRIPTION OF THE DRAWINGS

The present invention can be more fully understood by reading the subsequent detailed description and examples with references made to the accompanying drawings, wherein:

FIG. 1 is a block diagram of a control system in accordance with the embodiments of the present disclosure;

FIG. 2 is a flow diagram of a method in accordance with the embodiments of the present disclosure;

FIG. 3 is a flow diagram of a method in accordance with the embodiments of the present disclosure;

FIG. 4 is a schematic diagram of the waveforms in accordance with the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

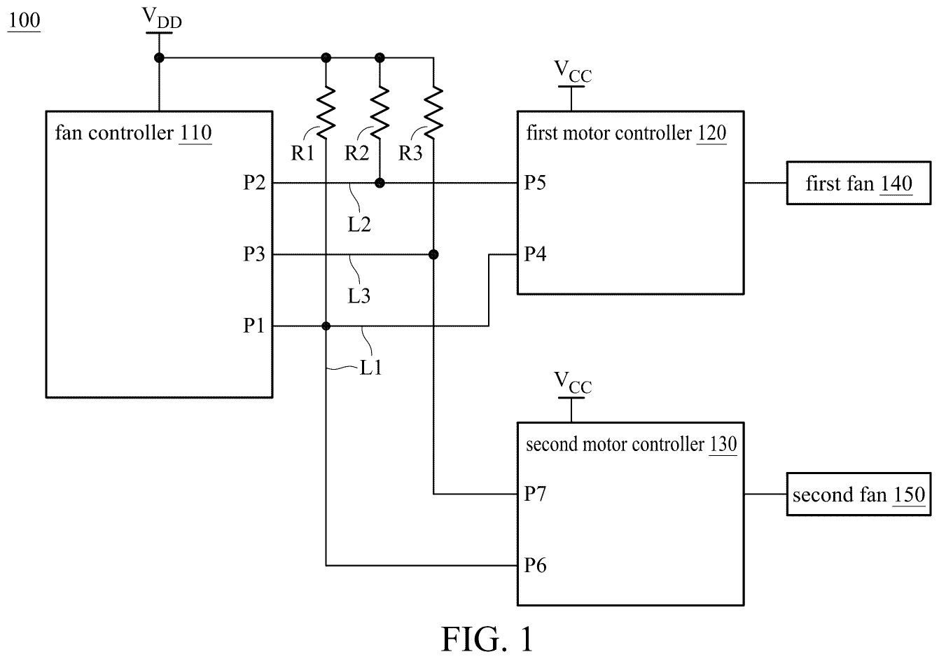

Refer to FIG. 1, FIG. 1 is a block diagram of a control system 100 in accordance with the embodiments of the present disclosure. The control system 100 comprises a fan controller 110, a first motor controller 120, and a second motor controller 130. The control system 100 is configured to control a the first fan 140 and a second fan 150. It should be noted that the number of motor controllers shown in FIG. 1 is just for illustration and should not be a limitation of the present disclosure. The control system 100 may have more or less motor controllers.

The fan controller 110 have a first pin P1, a second pin P2, and a third pin P3. The fan controller 110 is configured to control the first motor controller 120 and the second motor controller 130. The fan controller 110 may, for example, provides the process ability required to perform operating systems, programs, software, modules, and applications to implement methods in accordance with the embodiments of the present disclosure. For example, the fan controller 110 may comprise microprocessors, central processing units, the combination of general-purpose processors and specialized processors, and/or related chip sets. Furthermore, the fan controller 110 may also comprise a memory to store data required in operation. In some embodiments, the fan controller 110 is implemented by integrated circuits.

The first motor controller 120 has a fourth pin P4 and a fifth pin P5. The first motor controller 120 is coupled to the first fan 140. The first motor controller 120 is configured to receive instructions from the fan controller 110 and control the first fan 140 according to the instructions. For example, the first motor controller 120 may have a motor to control/drive the first fan 140.

The second motor controller 130 has a sixth pin P6 and a seventh pin P7. The second motor controller 130 is coupled to the second fan 150. The second motor controller 130 is configured to receive instructions from the fan controller 110 and control the second fan 150 according to the instructions. For example, the second motor controller 130 may have a motor to control/drive the second fan 150.

The first motor controller 120 and the second motor controller 130 may also, for example, provide the process ability required to perform operating systems, programs, software, modules, and applications to implement methods in accordance with the embodiments of the present disclosure. For example, the first motor controller 120 and the second motor controller 130 may comprise microprocessors, central processing units, the combination of general-purpose processors and specialized processors, and/or related chip sets. Furthermore, the first motor controller 120 and the second motor controller 130 may also comprise memories to store data required in operation. In some embodiments, the first motor controller 120 and the second motor controller 130 are implemented by integrated circuits.

The control system 100 further comprises a first line L1, a second line L2, and a third line L3. The first line L1 is connected to the first pin P1 and the forth pin P4. Furthermore, the first line L1 is connected to the first pin P1 and the sixth pin P6. The second line L2 is connected to the second pin P2 and the fifth pin P5. The third line L3 is connected to the third pin P3 and the seventh pin P7. Furthermore, the fan controller 110 is connected to a first power supply voltage VDD, the first motor controller 110 and the second motor controller 130 are connected to a second power supply voltage VCC. In some embodiments, the first power supply voltage VDD is different with the second power supply voltage VCC. A first end of a first register R1 is connected to the first power supply voltage VDD, and a second end of the first register R1 is connected to the first pin P1, the fourth pin P4, and the sixth pin P6. A first end of a second register R2 is connected to the first power supply voltage VDD, and a second end of the second register R2 is connected to the second pin P2 and the fifth pin P5. A first end of a third register R3 is connected to the first power supply voltage VDD, and a second end of the third register R3 is connected to the third pin P3 and the seventh pin P7.

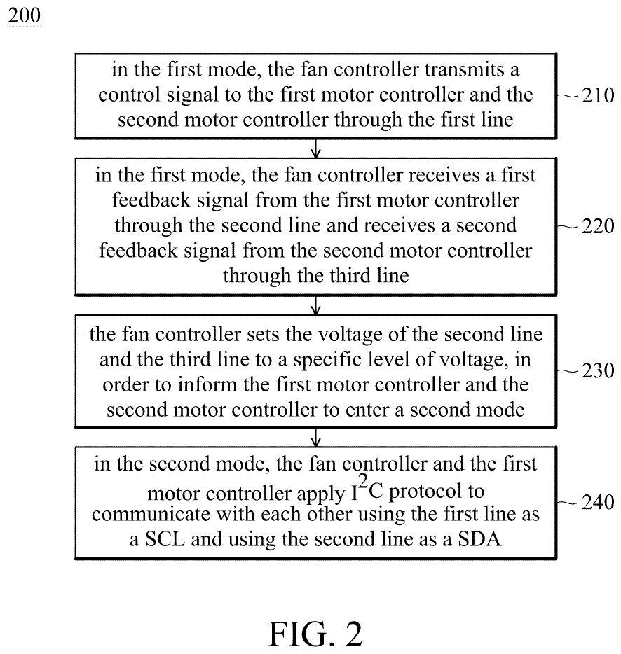

Refer to FIG. 2, FIG. 2 is a flow diagram of a method 200 in accordance with the embodiments of the present disclosure. Method 200 may be performed using control system 100. The fan controller 110, the first motor controller 120, and the second motor controller 130 are able to switch between a first mode and a second mode. In operation 210, in the first mode, the fan controller 110 transmits a control signal to the first motor controller 120 and the second motor controller 130 through the first line L1. The control signal is configured to control the rotation speed of the first fan 140 and the second fan 150. In some embodiments, the control signal is a pulse-amplitude modulation (PWM) signal. In some embodiments, the fan controller 110 controls the rotation speed of the first fan 140 and the second fan 150 by adjusting the duty ratio and/or frequency of the PWM signal. However, it should not be a limitation of the present disclosure.

Then, in operation 220, in the first mode, the fan controller 110 receives a first feedback signal from the first motor controller 120 through the second line L2 and receives a second feedback signal from the second motor controller 130 through the third line L3. The first feedback signal corresponds to the actual rotation speed of the first fan 140, and the second feedback signal corresponds to the actual rotation speed of the second fan 150. In some embodiments, the first feedback signal and the second feedback signal are frequency generator (FG) signals. In some embodiments, the first motor controller 120 and the second motor controller 130 comprises an open drain structure, the open drain structure is configured to generate the first feedback signal and the second feedback signal. For example, the open drain structure is configured to pull low the voltage of the second line L2 and the third line L3. When the open drain structure doesn't pull low the voltage of the second line L2 and the third line L3, the voltage of the second line L2 and the third line L3 becomes the first power supply voltage VDD. In some embodiments, the frequencies of the first feedback signal and the second feedback signal correspond to the actual rotation speed of the first fan 140 and the second fan 150.

In operation 230, the fan controller 110 sets the voltage of the second line L2 and the third line L3 to a specific level of voltage, in order to inform the first motor controller 120 and the second motor controller 130 to enter a second mode. In some embodiment, the specific level of voltage is a low level of voltage, but it should not be a limitation of the present disclosure. In other words, the fan controller 110 may set the voltage of the second line L2 and the third line L3 to a high level of voltage, in order to inform the first motor controller 120 and the second motor controller 130 to enter a second mode. In some embodiment, the fan controller 110 set the voltage of the second line L2 and the third line L3 to the specific level of voltage using the open drain structure therein.

In operation 240, in the second mode, the fan controller 110 and the first motor controller 120 apply Inter-Integrated Circuit (I²C) protocol to communicate with each other using the first line L1 as a serial clock line (SCL) and using the second line L2 as a serial data line (SDA). Similarly, in the second mode, the fan controller 110 and the second motor controller 130 apply I²C protocol to communicate with each other using the first line L1 as a SCL and using the third line L3 as a SDA. In the second mode, the fan controller 110 transmits a clock signal to the first motor controller 120 and the second motor controller 130 through the first line L1. In some embodiments, the clock signal conforms to the standard of I²C.

In the second mode, the fan controller 110 and the first motor controller 120 can communicate with each other through the second line L2, and the fan controller 110 and the second motor controller 130 can communicate with each other through the third line L3. In the embodiments of the present disclosure, the communication can be two-way. That is to say, the fan controller 110 can transmit instructions or messages to the first motor controller 120/the second motor controller 130 through the second line L2/the third line L3. The first motor controller 120/the second motor controller 130 can also transmit messages to the fan controller 110 through the second line L2/the third line L3. The messages transmitted on the second line L2/the third line L3 is data encoded according to I²C standard. In some embodiments, the first motor controller 120 transmits a first electronic parameter of the first motor controller 120 to the fan controller 110 through the second line L2. Similarly, the second motor controller 130 transmits a second electronic parameter of the second motor controller 130 to the fan controller 110 through the third line L3. In some embodiments, the first electronic parameter and the second electronic parameter comprise the temperature, voltage, output current, input power, and/or actual rotation speed of the first motor controller 120 and the second motor controller 130. In some embodiments, the first motor controller 120 and the second motor controller 130 comprise various sensors to measure the electronic parameter, such as temperature sensors, voltage sensors, tachometers, and so on.

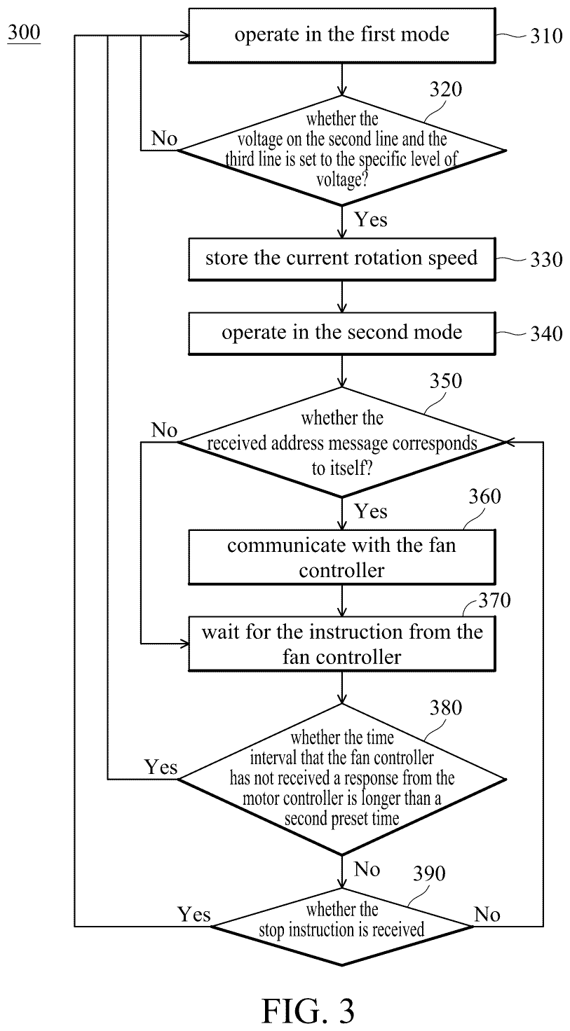

Refer to FIG. 3, FIG. 3 is a flow diagram of a method 300 in accordance with the embodiments of the present disclosure. Method 300 can be performed by the control system 100. In operation 310, the fan controller 110, the first motor controller 120, and the second motor controller 130 operate in the first mode. In operation 320, the first motor controller 120 and the second motor controller 130 respectively determines whether the voltage on the second line L2 and the third line L3 is set to the specific level of voltage. If the voltage on the second line L2 and the third line L3 isn't set to the specific level of voltage, method 300 goes back to operation 310. If the voltage on the second line L2 and the third line L3 is set to the specific level of voltage, method 300 proceeds to operation 330. In some embodiments, in operation 320, when the first motor controller 120 and the second motor controller 130 respectively determines that the voltage on the second line L2 and the third line L3 is set to the specific level of voltage over a first preset time T_preset (e.g. a preset/predetermined period of time), the first motor controller 120 and the second motor controller 130 perform operation 330 (i.e. switch to the second mode, as described below). In a preferable embodiment, the first preset time T_preset is the period of the first feedback signal corresponding to the lowest rotation speed of the first fan 140 in the first mode (i.e. the period of the signal on the second line L2 corresponding to the lowest rotation speed of the fan). The first motor controller 120 and the second motor controller 130 may comprise respective internal clock generator or timer for timing.

In operation 330, the first motor controller 120 and the second motor controller 130 store control signals corresponding to a current rotation speed in the internal memories. The current speed is the speed that the fan controller 110 currently (before entering the second mode) instructs the first motor controller 120 and the second motor controller 130 to achieve using the control signals. In operation 340, the fan controller 110, the first motor controller 120, and the second motor controller 130 operates in the second mode. In the second mode, if there is no instruction received from the fan controller 110, the first motor controller 120 and the second motor controller 130 respectively controls the first fan 140 and the second fan 150 rotates at the previously stored current rotation speed. After switching to the second mode, the fan controller 110 outputs clock signal for I²C communication from the first line L1, instead of outputting control signal configured to control the rotation speed from the first line L1. Thus, the first motor controller 120 and the second motor controller 130 have to store the current rotation speed in the memory. In this way, the first motor controller 120 and the second motor controller 130 can maintain the same rotation speed after entering the second mode.

Furthermore, the fan controller 110 sets both the voltage on the second line L2 and voltage on the third line L3 to the specific level of voltage. Thus, the first motor controller 120 and the second motor controller 130 will enter the second mode at the same time. In other words, all the motor controllers connected to the fan controller 110 will enter the second mode at the same time. There will not be a situation where one of the motor controllers is operating in the second mode but other motor controllers are operating in the first mode.

In operation 350, the fan controller 110 transmits address message through the second line L2 and the third line L3. The address message corresponds to one of the motor controller connected to the fan controller 110 (such as the first motor controller 120 or the second motor controller 130). The first motor controller 120 and the second motor controller 130 determine whether the received address message corresponds to itself. If the received address message doesn't correspond to itself, the first motor controller 120 and the second motor controller 130 perform operation 370. If the received address message corresponds to itself, the first motor controller 120 and the second motor controller 130 perform operation 360.

In some embodiments, the fan controller 110 transmits the same address message sequentially on each of the lines used as SDAs, in a manner that transmits the message on one line at a time, in order to find the motor controller that corresponds to the address message. For example, the fan controller 110 may transmit the address message on one of the line used as SDA (such as the second line L2) and then transmits the address message on another line used as SDA (such as the third line L3). The fan controller 110 may repeat the aforementioned operations until the motor controller that is corresponds to the address message is found. In some embodiments, the motor controller transmits a deny message to the fan controller 110, after determining that the address message doesn't correspond to itself. The fan controller 110 continues to transmit the address message on the other line after receiving the deny message.

In operation 360, the motor controller corresponding to the address message communicates with the fan controller 110. Description below takes the situation in which the address message corresponds to the first motor controller 120 as example for illustration. In some embodiments, when the first motor controller 120 determines that the address message corresponds to itself, the first motor controller 120 transmits an acknowledge message through the second line L2. The fan controller 110 stars to communicate with the first motor controller 120 through the second line L2 after receiving the acknowledge message. The fan controller 110 may transmit a request message to the first motor controller 120 through the second line L2. The first motor controller 120 transmits the electronic parameter to the fan controller 110 through the second line L2 after receiving the request message. Optionally, the request message may instruct the first motor controller 120 to transmit certain electronic parameter. For example, the request message may instruct the first motor controller 120 to transmit temperature and output power.

Furthermore, the fan controller 110 may transmit an instruction including a specific rotation speed to the first motor controller 120 through the second line L2. The first motor controller 120 controls the first fan 140 to rotate at the specific rotation speed after receiving the instruction. Then, after switching from the second mode to the first mode, the first motor controller 120 still controls the first fan 140 to rotate at the specific rotation. In other words, after receiving the instruction and switching back to the first mode, the first motor controller 120 ignores the control signal from the fan controller 110 and controls the first fan 140 to rotate at the specific rotation. Thus, by switching to the second mode, the fan controller 110 is able to individually sets the rotation speed of one of the motor controllers. Other motor controllers which do not receive the instruction rotate at the rotation speed corresponding to the control signal after switching back to the first mode. In some embodiments, the instruction transmitted form the fan controller 110 includes values of other electronic parameters (e.g. output power) to cause the motor controllers to adjust the indicated electronic parameters to those values.

In operation 370, the first motor controller 120 and/or the second motor controller 130 wait for the instruction from the fan controller 110. While the fan controller 110 is communicating with one of the motor controllers, other motor controllers perform operation 370 and maintain the current rotation speed (or the specific speed). In some embodiments, the motor controllers perform operation 370 after responding to a command from the fan controller 110 and keep waiting for the next instruction of the fan controller 110. For example, the motor controllers perform operation 370 after transmitting the electronic parameter. Alternatively, the motor controllers perform operation 370 after rotating at the specific rotation speed.

In operation 380, the fan controller 110 determines whether the time interval that it has not received a response from the first motor controller 120 or the second motor controller 130 is longer than a second preset time. In some embodiments, the fan controller 110 determines whether the time interval that it has not received a response from the motor controller after transmitting the address message on one of the lines being used as the SDA is longer than a second preset time. In some embodiments, the fan controller 110 determines whether the time interval that it has not received a response from the motor controller after transmitting the request message or the instruction is longer than a second preset time. In practice, some of the motor controllers connected to the fan controller 110 may not support I²C communication. However, the fan controller 110 is unable to know which motor controller(s) supports I²C communication. Thus, performing operation 380 can avoid the system to enter an idle state for a long time, while trying to communicate with a motor controller which doesn't support I²C communication. If the fan controller 110 determines that the time interval that it has not received a response from the first motor controller 120 or the second motor controller 130 is longer than the second preset time, the fan controller 110 informs all the connected motor controllers to switch to the first mode (e.g. using the stop instruction described below). If the fan controller 110 determines that the time interval that it has not received a response from the first motor controller 120 or the second motor controller 130 for isn't longer than the second preset time, the method 300 proceeds to operation 390.

In operation 390, the first motor controller 120 and the second motor controller 130 determine whether the stop instruction is received. The fan controller 110 transmits the stop instruction to the first motor controller 120 and the second motor controller 130 on the second line L2 and the third line L3 respectively, in order to inform the first motor controller 120 and the second motor controller 130 to switch to the first mode. Thus, if the stop instruction is received (via the first motor controller 120 and the second motor controller 130), the method 300 goes back to operation 310. If the stop instruction isn't received (via the first motor controller 120 and the second motor controller 130), the method 300 goes back to operation 350. The fan controller 110 may transmit the stop instruction after the predetermined task is completed. For example, the fan controller 110 may transmit the stop instruction after obtaining the required electronic parameter from at least one motor controller, or after setting the rotation speed of at least one motor controller. Alternatively, the fan controller 110 may also transmit the stop instruction when the time interval it has not receive the response form the motor controller is longer than the second preset time, as described above.

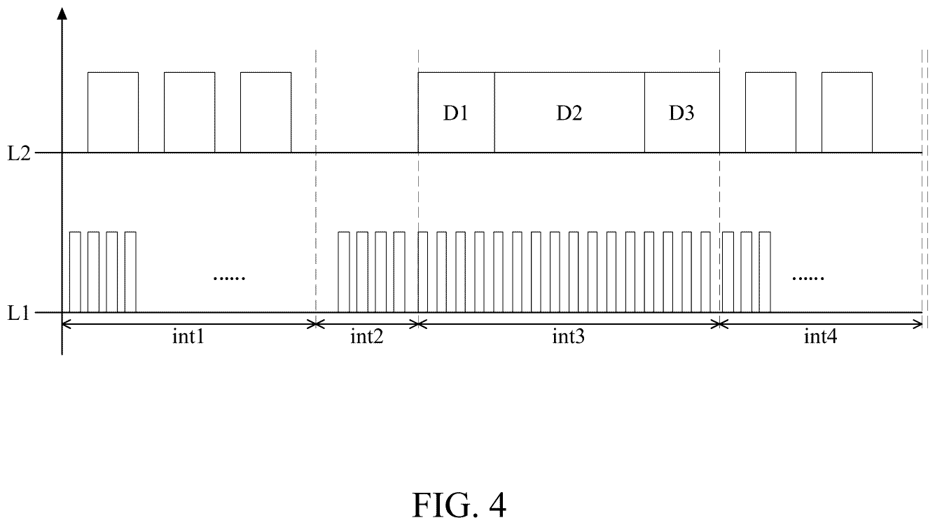

Refer to FIG. 4, is a schematic diagram of the waveforms in accordance with the embodiments of the present disclosure. The upper part of the FIG. 4 illustrates the signals on the second line L2. The lower part of the FIG. 4 illustrates the signals on the first line L1. In the first interval int1, the fan controller and the first motor controller 120 operate in the first mode. Thus, the signal on the first line L1 is the control signal (such as the PWM signal) generated by the fan controller, and the signal on the second line L2 is the feedback signal generated by the first motor controller 120. In the second interval int2, the fan controller 110 sets the voltage on the second line L2 to the specific level of voltage. In the embodiment of FIG. 4, the fan controller 110 sets the voltage on the second line L2 to the low level. Moreover, in the second interval int2, the signal on the first line L1 is still the control signal generated by the fan controller 110.

In the third interval int3, the fan controller 110 and the first motor controller 120 operated in the second mode. Thus, the signal on the first line L1 is the clock signal generated by the fan controller 110. As described above, the clock signal conforms to the I²C standard. For example, the width (duty cycle) of the clock signal may be 50%. In some embodiments, as shown in the figure, the width (duty cycle) of the control signal (such as the PWM signal) transmitted from the fan controller 110 in the first mode is larger than the width of the clock signal transmitted in the second mode. In some embodiments, the fan controller 110 comprises a signal generator configured to generate the control signal (e.g. PWM signal) and a clock generator configured to generate the clock signal. The fan controller 110 selects to output the signal generated by the signal generator or the signal generated by the clock signal using a switch or a multiplexer to output the control signal and the clock signal in different modes.

In the third interval int3, the signal on the second line L2 is the data transmitted/received between the fan controller 110 and the first motor controller 120 applying the I²C standard. Data D1 is the data required to be exchanged before the communication, such as the address message, the acknowledge message, and so on. For example, data D2 is the request message, the electronic parameter, instruction, and so on. Data D3 is the stop instruction. In the fourth interval int4, the fan controller 110 and the first motor controller 120 switch to the first mode in response to the stop instruction.

By switching to the second mode, embodiments of the present disclosure can perform complicate communications with the motor controller in order to obtain various information from the motor controller or transmit instructions to the motor controller to control the motor controller. Furthermore, embodiments of the present disclosure provide the control signal to all the motor controllers through single line, so the hardware cost can be reduced.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for controlling a motor controller, comprising:
in a first mode:
transmitting a control signal from a fan controller to a first motor controller through a first line;
transmitting a first feedback signal from the first motor controller to the fan controller through a second line, wherein the control signal is configured to control a rotation speed of a first fan coupled to the first motor controller, and the first feedback signal corresponds to an actual rotation speed of the first fan;
setting a voltage of the second line to a specific level of voltage to inform the first motor controller to enter a second mode using the fan controller.

2. The method as claimed in claim 1, further comprising:
in the second mode:
applying an Inter-Integrated Circuit (I²C) protocol to communicate between the fan controller and the first motor controller using the first line as a serial clock line (SCL) and using the second line as a serial data line (SDA).

3. The method as claimed in claim 1, further comprising:
in the second mode:
transmitting a clock signal from the fan controller to the first motor controller through the first line and transmitting a first electronic parameter from the first motor controller to the fan controller through the second line.

4. The method as claimed in claim 3, wherein the electronic parameter comprises a temperature, a voltage, an output current, an output power, and/or an actual rotation speed of the first motor controller.

5. The method as claimed in claim 1, wherein the control signal is a pulse-amplitude modulation (PWM) signal, and the first feedback signal is a frequency generator (FG) signal.

6. The method as claimed in claim 1, wherein the first motor controller is configured to switch to the second mode, when the first motor controller determines that the voltage of the second line is set to the specific level of voltage over a preset time.

7. The method as claimed in claim 6, wherein the preset time is the period of the first feedback signal corresponding to a lowest rotation speed of the first fan in the first mode.

8. The method as claimed in claim 1, further comprising: storing the control signal corresponding to a current rotation speed using the first motor controller, before switching to the second mode; and controlling the first fan to rotate at the current rotation speed using the first motor controller, after switching to the second mode.

9. The method as claimed in claim 1, further comprising:
transmitting a stop instruction from the fan controller to the first motor controller through the second line to inform the first motor controller to switch to the first mode, in the second mode.

10. The method as claimed in claim 1, further comprising:
transmitting an instruction from the fan controller to the first motor controller through the second line to set the rotation speed of the first fan to a specific rotation speed, in the second mode.

11. The method as claimed in claim 10, further comprising:
controlling the first fan to rotate at the specific rotation speed and ignoring the control signal using the first motor controller, after switching from the second mode to the first mode.

12. The method as claimed in claim 1, further comprising:
in the first mode:
transmitting the control signal from the fan controller to a second motor controller through the first line;
transmitting a second feedback signal from the second motor controller to the fan controller through a third line;
wherein the control signal is configured to control a rotation speed of a second fan coupled to the second motor controller, and the second feedback signal corresponds to an actual rotation speed of the second fan;
setting a voltage of the third line to the specific level of voltage to inform the second motor controller to enter the second mode using the fan controller; and
in the second mode:
applying an I²C protocol to communicate between the fan controller and the second motor controller using the first line as the SCL and using the third line as the SDA;
transmitting the clock signal from the fan controller to the second motor controller through the first line and transmitting a second electronic parameter from the second motor controller to the fan controller through the third line.

13. The method as claimed in claim 1, wherein the fan controller transmits an address message on the second line to communicate with the first motor controller corresponding to the address message, in the second mode.

14. The method as claimed in claim 1, wherein the fan controller informs the first motor controller to switch to the first mode, in response to a determination that a time interval that the fan controller has not received a response from the first motor controller is longer than a preset time.

15. A control system, comprising:
a fan controller; and
a first motor controller, coupled to a first fan, wherein the first motor controller is connected to the fan controller through a first line and a second line;
wherein, in a first mode:
the fan controller is configured to transmit a control signal to the first motor controller through the first line; the fan controller is configured to receive a first feedback signal from the first motor controller through the second line, wherein the control signal is configured to control a rotation speed of a first fan coupled to the first motor controller, and the first feedback signal corresponds to an actual rotation speed of the first fan; and
the fan controller is configured to set a voltage of the second line to a specific level of voltage to inform the first motor controller to enter a second mode.

16. The control system as claimed in claim 15, wherein in the second mode:
the fan controller and the first motor controller are configured to apply an Inter-Integrated Circuit (I²C) protocol to communicate with each other using the first line as a serial clock line (SCL) and using the second line as a serial data line (SDA).

17. The control system as claimed in claim 15, wherein, in the second mode, the fan controller is configured to transmit a clock signal to the first motor controller through the first line, and the fan controller is configured to receive a first electronic parameter from the first motor controller through the second line.

18. The control system as claimed in claim 17, wherein the electronic parameter comprises a temperature, a voltage, an output current, an output power, and/or an actual rotation speed of the first motor controller.

19. The control system as claimed in claim 15, wherein the first motor controller is configured to switch to the second mode when the first motor controller determines that the voltage of the second line is set to the specific level of voltage over a preset time.

20. The control system as claimed in claim 19, wherein the preset time is the period of the first feedback signal corresponding to a lowest rotation speed of the first fan in the first mode.

21. The control system as claimed in claim 15, wherein the first motor controller is configured to store the control signal corresponding to a current rotation speed before switching to the second mode, and the first motor controller is configured to control the first fan to rotate at the current rotation speed after switching to the second mode.

22. The control system as claimed in claim 15, wherein, in the second mode, the fan controller is configured to transmit a stop instruction to the first motor controller through the second line to inform the first motor controller to switch to the first mode.

23. The control system as claimed in claim 15, wherein, in the second mode, the fan controller is configured to transmit an instruction to the first motor controller through the second line to set the rotation speed of the first fan to a specific rotation speed.

24. The control system as claimed in claim 23, wherein the first motor controller is configured to control the first fan to rotate at the specific rotation speed and to ignore the control signal, after switching from the second mode to the first mode.

25. The control system as claimed in claim 15, wherein control system further comprises a second motor controller, the second motor controller is connected to the fan controller through the first line and a third line;
in the first mode:
the fan controller is configured to transmit the control signal to the second motor controller through the first line, the fan controller is configured to receive a second feedback signal from the second motor controller through the third line; wherein the control signal is configured to control a rotation speed of a second fan coupled to the second motor controller, and the second feedback signal corresponds to an actual rotation speed of the second fan;
the fan controller is configured to set a voltage of the third line to the specific level of voltage to inform the second motor controller to enter the second mode; and
in the second mode:
the fan controller and the first motor controller are configured to apply an I²C protocol to communicate with each other using the first line as the SCL and using the third line as the SDA;
the fan controller is configured to transmit the clock signal to the second motor controller through the first line and to receive a second electronic parameter from the second motor controller through the third line.
